(19) United States
(12) Patent Application Publication
(10) Pub. No.: US 2005/0206956 A1
(43) Pub. Date: Sep. 22, 2005

(54) Printing system, method of controlling printing and program for use in printing systems

(75) Inventor: Takahiro Hagiwara, Chiba-shi (JP)

Correspondence Address: FOLEY AND LARDNER;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 10/800,634

(22) Filed: Mar. 16, 2004

(51) Int. Cl. G06F 15/00

(52) U.S. Cl. 358/1.18; 358/1.12

(57) ABSTRACT

A CPU in an MFP apparatus opens a PDL file that is stored in an auxiliary memory device, stores page description PDL in the auxiliary memory device, stores a print setting state in the auxiliary memory device, outputs raster data by a rendering process, stores the raster data in the auxiliary memory device when a predetermined time period expires, and generates, when the predetermined time period does not expire, a page-unit PDL and stores it in the auxiliary memory device, generates a print job control script file and stores it in the auxiliary memory device, and closes the PDL file.

### BACKGROUND OF THE INVENTION

1. Field of the Invention

The present invention relates to a printing system that performs printing using print data such as PDL, a method of controlling printing, and a program for use in printing systems.

2. Description of the Related Art

In the prior art, there is known a multi-function peripheral (MFP) that stores print data (PDL: Page Description Language) as such and reuses it at the time of re-printing, or subjects input PDL to RIP (Raster Image Processing), compresses and stores the generated raster data (also known as “bit-map data”) and decompresses and prints it out at the time of re-printing.

In the case where print data is stored as such, however, the following problem will arise. Although this permits printing that directly uses the data stored for re-printing, it is not possible to perform printing using mixed print data in which print data output from a plurality of applications are combined.

In addition, in the method of storing the compressed raster data obtained by RIP, replacement of pages is possible by edit functions. However, depending on originals, the image quality deteriorates due to Nin1 involving enlargement/reduction or rotation, or editing of a booklet.

### BRIEF SUMMARY OF THE INVENTION

The object of an aspect of the present invention is to provide a printing system with a re-print function capable of performing re-printing without degrading editing functions with little deterioration in image quality, a method of controlling printing, and a program for use in printing systems.

The object of another aspect of the invention is to provide a printing system capable of producing a desired print document with high efficiency by pre-registering re-print procedures that are executed repeatedly, a method of controlling printing, and a program for use in printing systems.

According to an aspect of the present invention, there is provided a printing system comprising: input means for inputting print data; division means for dividing the print data input by the input means into page units; first addition means for adding print setting state data to the print data of each of the page units divided by the division means; second addition means for adding page description data to the print data of each of the page units divided by the division means; generation means for generating a print job control script file in association with the print data divided by the division means; and print means for performing printing in accordance with the print job control script file generated by the generation means.

According to another aspect of the present invention, there is provided a method of controlling printing, comprising: dividing input print data into page units; adding print setting state data to the print data of each of the divided page units; adding page description data to the print data of each of the divided page units; generating a print job control script file in association with the divided print data; and controlling printing in accordance with the generated print job control script file.

According to another aspect of the present invention, there is provided a program that causes a printing system, which effects printing using given print data such as a Page Description Language, comprising: dividing the print data into page units; adding print setting state data to the print data of each of the divided page units; adding page description data to the print data of each of the divided page units; generating a print job control script file in association with the divided print data; and controlling printing in accordance with the generated print job control script file.

Additional objects and advantages of an aspect of the invention will be set forth in the description which follows, and in part will be obvious from the description, or may be learned by practice of the invention. The objects and advantages of an aspect of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the embodiments given below, serve to explain the principles of an aspect of the invention.

FIG. 1 is a block diagram that schematically shows the structure of an MFP apparatus according to the present invention;

FIG. 2 shows an external structure of the MFP apparatus;

FIG. 3 illustrates the outline of a PDL division process;

FIG. 4 illustrates the outline of the PDL division process;

FIG. 5 is a flow chart illustrating the operation in the PDL division process;

FIG. 6 is a flow chart illustrating a re-printing process using division PDL in a folder and a print control script;

FIG. 7 shows a system configuration as an example of the mode of use;

FIG. 8 shows an example of the display screen on a key input display device;

FIG. 9 is a view for explaining a style template;

FIG. 10 is a flow chart illustrating an editing operation;

FIG. 11 is a flow chart illustrating the editing operation;

FIG. 12 shows an example in which a style template by relative designation is used;

FIG. 13 shows accumulated data stored in a folder;

FIG. 14 is a view for explaining a preview;

FIG. 15 is a flow chart illustrating a printing process;

FIG. 16 is a flow chart illustrating the printing process;

FIG. 17 shows an example of display for print settings on the key input display device;

FIG. 18 shows an example of data stored in respective folders;

FIG. 19 shows a preview result;

FIG. 20 shows an applied example;

FIG. 21 shows an example of a style template;

FIG. 22 shows an example of a print result;

FIG. 23 shows an example of display of print settings on the key input display device;

FIG. 24 shows an example of data stored in respective folders;

FIG. 25 shows a preview result;

FIG. 26 is a view for explaining functions provided in a printer driver; and

FIG. 27 shows an example in which the functions are provided in the driver.

### DETAILED DESCRIPTION OF THE INVENTION

An embodiment of the present invention will now be described with reference to the accompanying drawings.

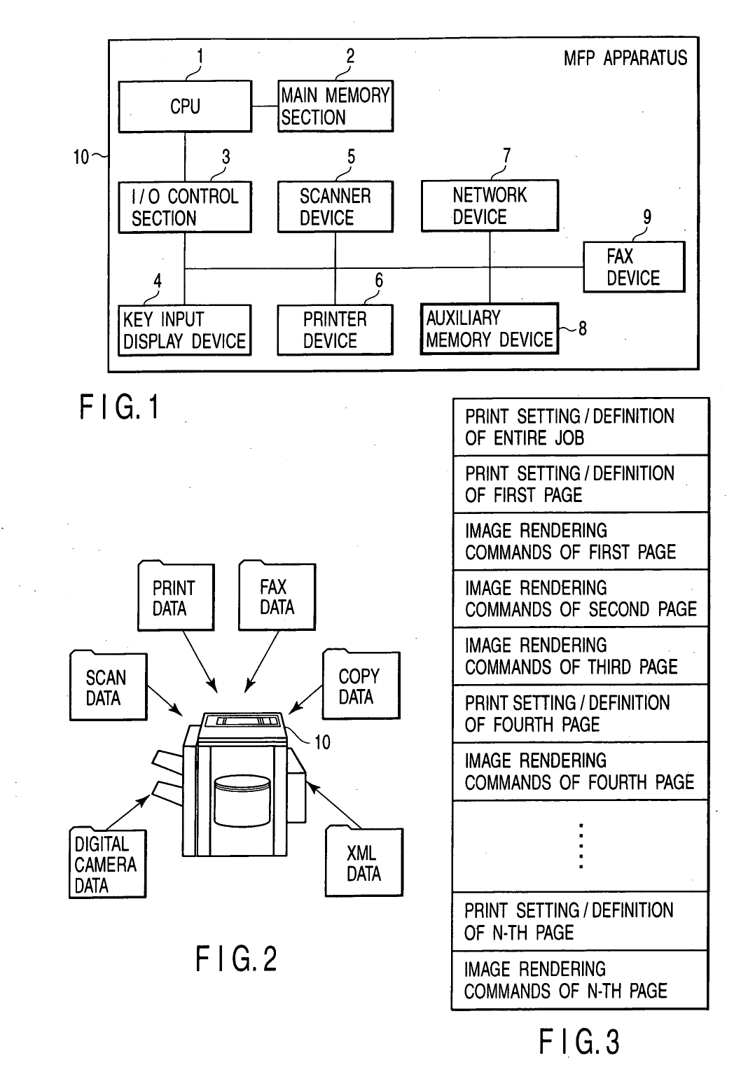

FIG. 1 schematically shows an MFP (Multi-Function Peripheral) apparatus 10 according to the invention. The MFP apparatus 10 includes a CPU 1 that controls the entirety of the apparatus. The CPU 1 is connected to a main memory section 2, an I/O control section 3, a key input display device (display means) 4, a scanner device 5, a printer device (print means) 6, a network device 7, an auxiliary memory device (storage device) 8 and a facsimile (FAX) device 9.

FIG. 2 shows an external structure of the MFP apparatus 10. As is illustrated in FIG. 2, the modern MFP apparatus 10 receives various digital data such as scan data, print data, FAX data, copy data, digital camera data and XML data. The MFP apparatus 10 stores such data in the auxiliary memory device 8 and prints it out from the printer device 6, where necessary.

There are two methods for storing data in the auxiliary memory device 8: a method wherein raster data, which forms, like image data, an image with a group of a plurality of pixels, is compressed and stored, and a method wherein data is stored in a PDL format, like print data. In general terms, in the case of the former method, typical data formats can directly be output to the printer device and can be printed out. Editing such as insertion and deletion of a page and, in some cases, rotation of a page can be performed. However, Nin1, which involves enlargement and reduction, and editing of a booklet, a tablet, etc. is prohibited in principle. Even where such Nin1 and editing are permitted, the image quality deteriorates in many cases.

On the other hand, the latter method is not suited to editing since the same document is simply stored for re-printing. In short, if a priority is given to the editing function, the image quality deteriorates. If a priority is given to the image quality, the editing function is restricted.

The present invention aims at providing a re-printing function with fewer restrictions to editing functions and with no degradation in image quality, although the kind of data is limited to print data. The same function can be provided for scan data or digital camera data by storing such data as PDL, but this processing scheme requires a heavy processing load and is not general. Thus, the processing of such data is not performed in the present invention.

A PDL division process in the above-described structure is described below.

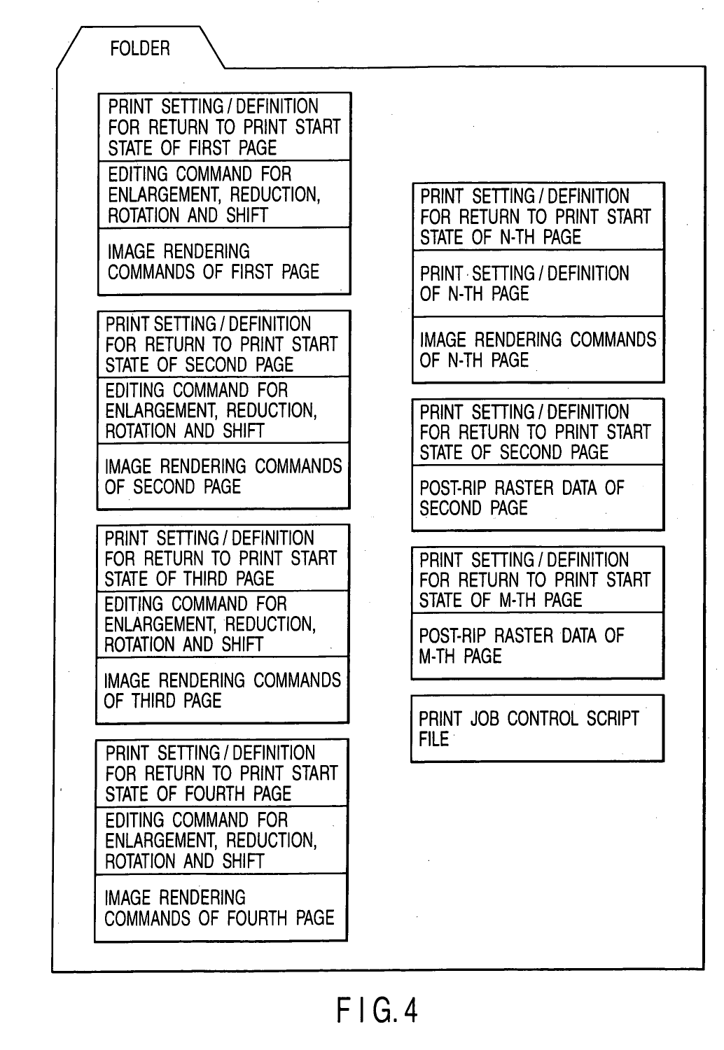

FIG. 3 and FIG. 4 illustrate the outline of the PDL division process which characterizes the present invention. In general, PDL is created in the form of a document data comprising a plurality of pages, as shown in FIG. 3. A beginning portion of the PDL includes the content of settings for the entire document and commands for setting a finishing process (stapling, punching, etc.) in a later step. In a subsequent portion of the PDL, commands for setting the sheet size/kind, performance/non-performance of double-side printing, and the number of copies are added. Setting may be omitted if the same setting as with the preceding page is executed. In the next portion of the PDL, commands for actually rendering characters, graphics and photo images, which are main data, are added. The PDL can thus be classified into the three portions.

In the present invention, the PDL shown in FIG. 3 is divided into PDL shown in FIG. 4.

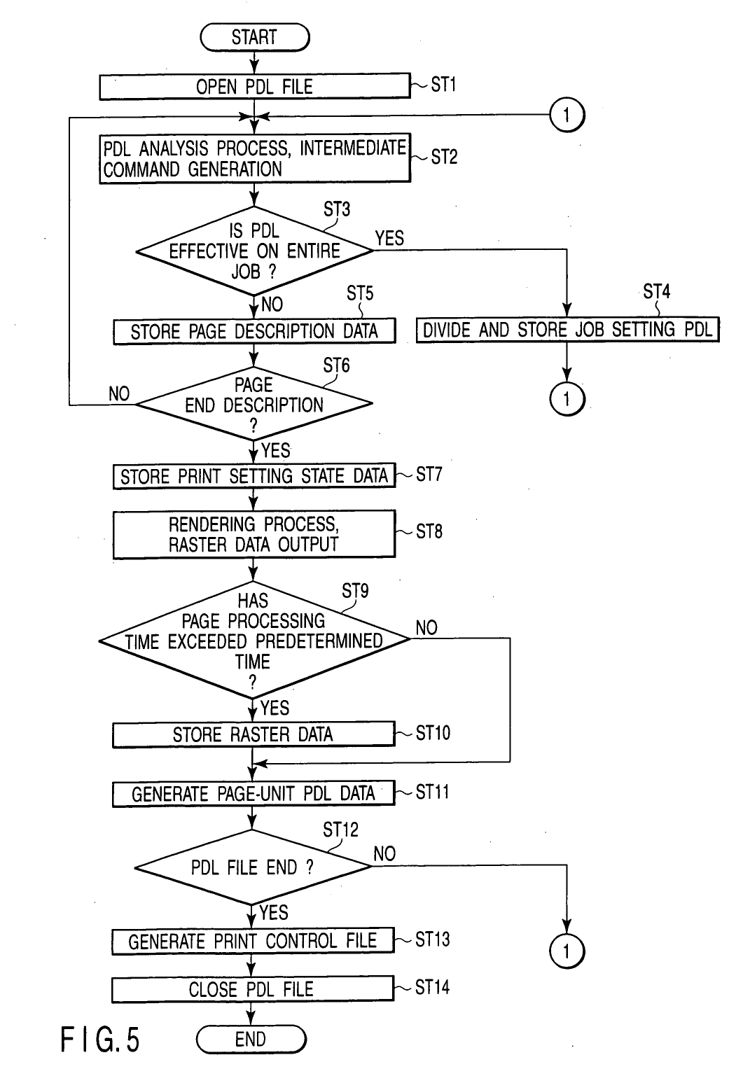

The operation in the aforementioned PDL division process will now be described referring to a flow chart of FIG. 5.

To start with, the CPU 1 opens a PDL file that is stored in the auxiliary memory device 8 (ST1). The CPU 1 subjects the PDL (print data) to an analysis process and generates an intermediate command (ST2).

The CPU 1 checks whether the PDL has an effect on the entire job (ST3).

If “Yes” in step ST3, the CPU 1 functions as division means and divides the job-setting PDL and stores the divided job-setting PDL in the auxiliary memory device 8, and control returns to step ST2 (ST4).

If “No” in step ST3, the CPU 1 functions as addition means and stores page description data in the auxiliary memory device 8 (ST5) and checks whether a page end description is present (ST6). If there is no page end description in step ST6, the CPU 1 returns to step ST2.

If the page end description is present in step ST6, the CPU 1 functions as addition means and stores print setting state data in the auxiliary memory device 8 (ST7) and subjects the data to a rendering process and outputs raster data (image data) (ST8).

The CPU 1 checks, as control means, whether a page processing time has exceeded a predetermined time period (ST9). If the predetermined time period is exceeded, the CPU 1 stores the raster data in the auxiliary memory device 8 (ST10).

If the predetermined time period is not exceeded in step ST9, or after step ST10 is finished, the CPU 1 generates page-unit PDL data and stores it in the auxiliary memory device 8 (ST11).

The CPU 1 checks whether the PDL file ends or not (ST12). If the PDL file does not end, the CPU 1 returns to step ST2.

If the PDL file ends in step ST12, the CPU 1 generates a print control file (print job control script file) and stores it in the auxiliary memory device 8 (ST13), and the CPU 1 closes the PDL file and finishes the present process (ST14).

The divided PDL comprises a PDL description section (print setting state data) for re-setting each page in a print start state; an editing PDL description section (page description data) that defines variables necessary for performing enlargement, reduction, rotation and shift at the time of re-printing, and enables acquisition of a desired editing result by setting of values at the time of print execution; and a PDL description section for actual rendering of an image. As is shown in FIG. 4, for example, first-page PDL data is stored in a folder. In the first-page PDL data, the print setting state data is “print setting/definition for return to first-page print start state”, the page description data is “editing commands for enlargement, reduction, rotation and shift”, and the PDL description section for actual image rendering is “first-page image description commands.”

At this time, the CPU 1 has a function of measuring a print processing time and storing, if the print processing time exceeds a predetermined value, the raster data at the same time (see steps ST9 and ST10). In FIG. 4, second-page raster data, for instance, is stored in the folder as “print setting/definition for return to second-page print start state” and “second-page post-RIP raster data.” The stored raster data is used to improve the print speed for printing that requires no editing and causes no degradation in image quality.

At last, a print control script file (hereinafter referred to as “print control file”) for gathering the divided PDL and handling the gathered PDL as a print job is generated (see step ST13).

The above-described data items are stored and managed in an imaginary storage area called “folder” in the auxiliary memory device 8.

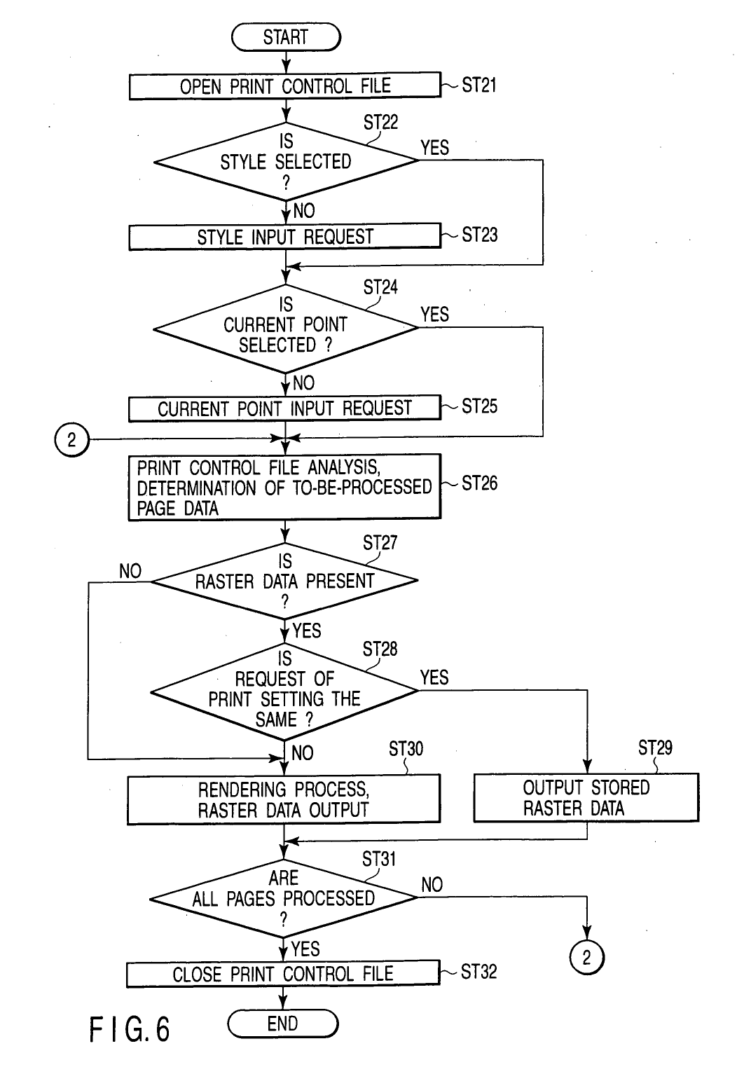

Next, referring to a flow chart of FIG. 6, a description is given of a re-printing process using the above-described divided PDL and print control file in the folder.

When a PDL print instruction is issued from the key input display device 4, the CPU 1 opens the print control file of the PDL stored in the auxiliary memory device 8 (ST21).

The CPU 1 checks whether style selection is made (ST22). If style selection is not made, the CPU 1 requests the input of the style (ST23).

The CPU 1 then checks whether a current point is selected (ST24). If the current point is not selected, the CPU 1 selects the input of the current point (ST25).

If the current point is selected in step ST24, or if the current point is input in response to the input request in step ST25, the CPU 1 analyzes the print control file and determines to-be-processed page data (ST26).

Then, the CPU 1 checks whether raster data is present (ST27). If there is raster data, the CPU 1 determines whether the print setting request is the same (ST28).

If the print setting request is the same in step ST28, the raster data stored in the auxiliary memory device 8 is output (ST29).

If raster data is not present in step ST27, or if the print setting request is not the same in step ST28, the CPU 1 executes a rendering process and outputs raster data (ST30).

If all pages are not processed, the CPU 1 returns to step ST26 (ST31). If all pages are processed, the CPU 1 closes the print control file of the PDL in the auxiliary memory device 8 and completes the process (ST32).

Next, an editing function using the divided PDL is described.

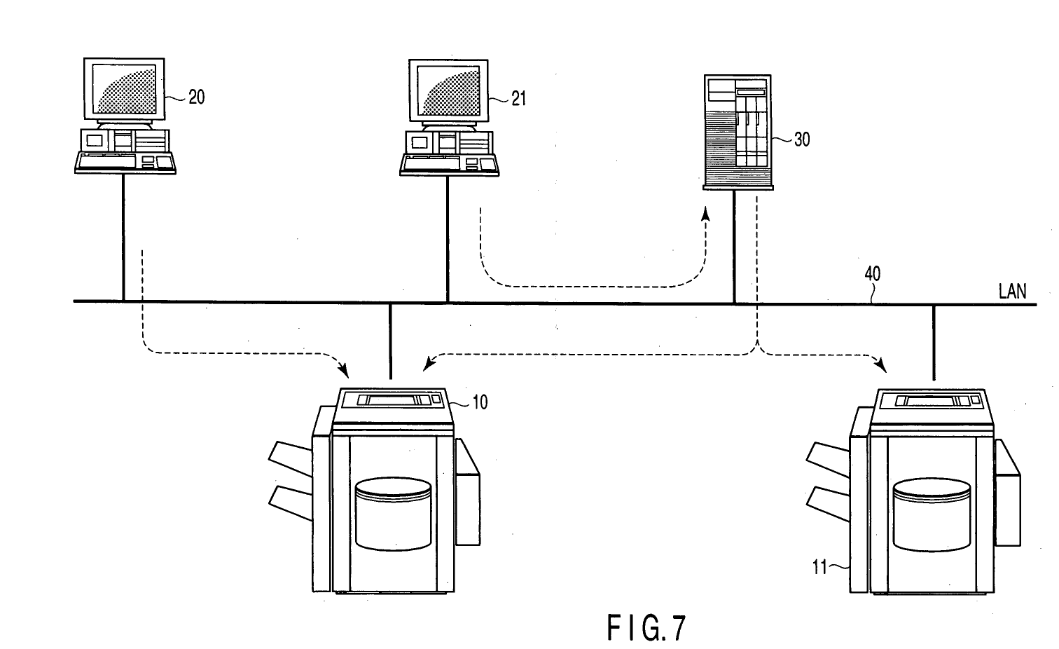

FIG. 7 shows a system configuration as an example of the mode of use. In FIG. 7, client's personal computers (PC) 20 and 21, an appliance server 30 that provides various services and MFP apparatuses 10 and 11 are connected over a network (communication means such as a LAN) 40.

The client's PC 20 or PC 21 is capable of using a Web client or performing operations on the mode screen, similarly with the key input display device 4 of the MFP apparatus 10, 11. In the description below, the operation on the key input display device 4 of the MFP apparatus 10 or 11 is described by way of example.

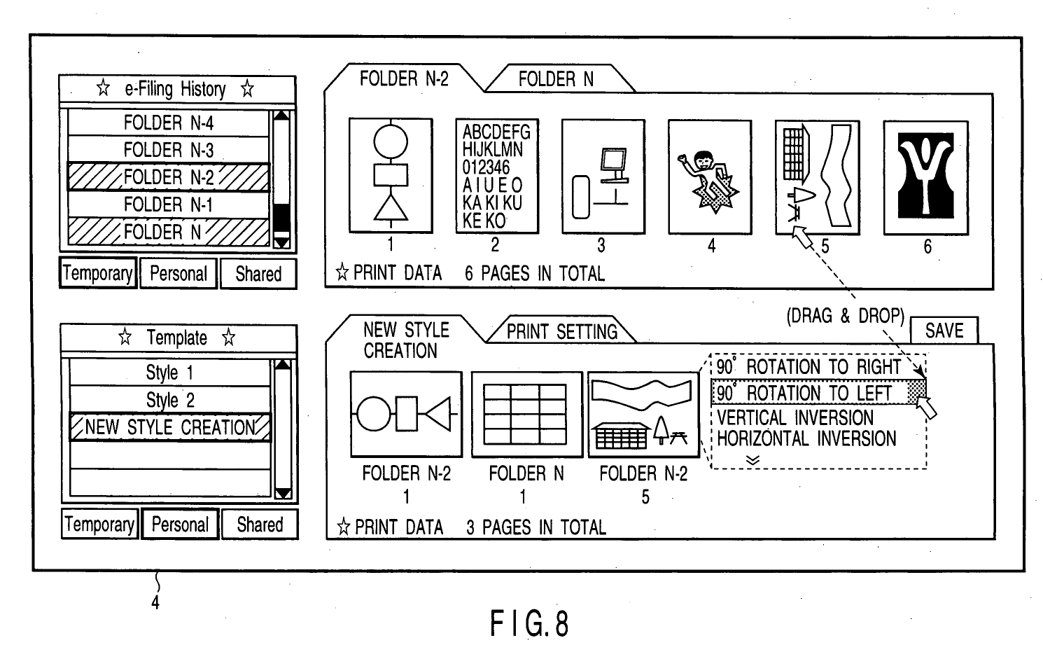

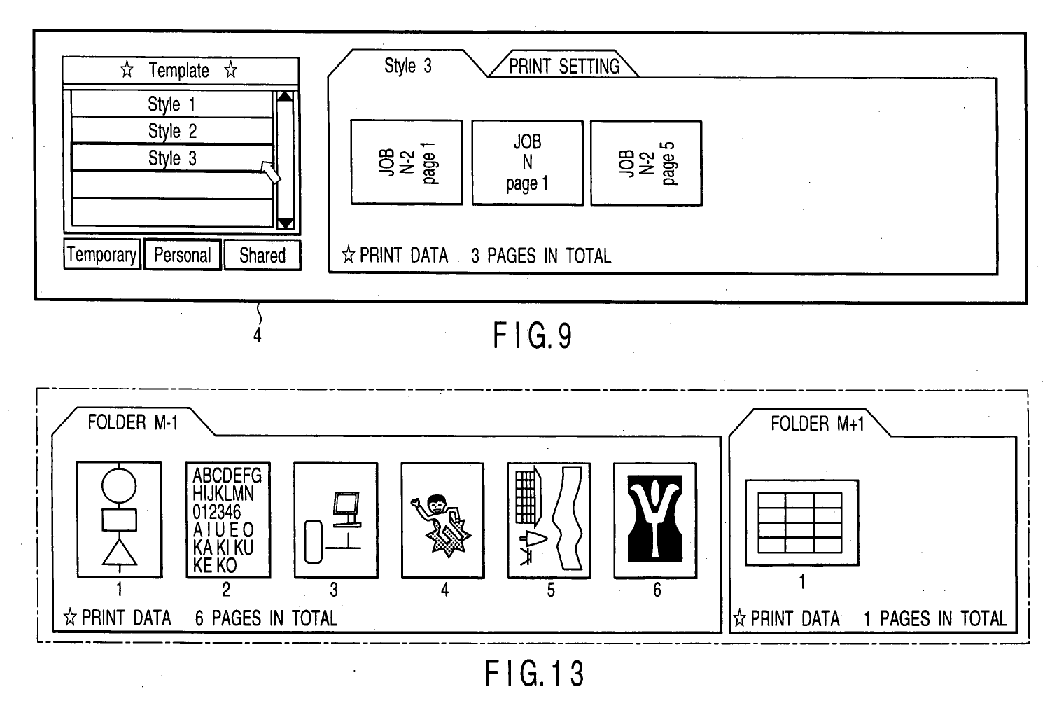

FIG. 8 shows an example of a screen on the key input display device 4, which is used to prepare a style template for producing and editing a print job control script for printing, by using PDL data stored in the auxiliary memory device 8.

On the screen, “e-Filing History” is classified into three categories: “Shared,” “Personal,” and “Temporary.” In this example, folder N−2 in the category “Temporary” is selected, and accumulation data stored in this folder is displayed on the upper right area of the screen in the form of thumbnails. The term “e-Filing” stands for electronic-filing.

The character “N” added to the folder name indicates a folder of the latest stored data item when the screen is opened. An immediately preceding data folder is indicated by N−1, and a further preceding data folder is indicated by N−2. Although not displayed on the screen, N+1 indicates an immediately following data folder, and N+2 indicates the next following data folder. In short, folders in the folder list are arranged in chronological order.

Template styles, displayed below “e-Filing History,” indicate setting information for defining to-be-printed data. According to this designation method, link data on links to pages in the folders and print operations such as a finishing operation are defined. The link data may designate page data in the folder by absolute designation, or may designate page data by relative designation on the basis of a current folder that is to be described below. To begin with, as a useful function, a description is given using a style plate that is set by relative designation.

On the temperate forming screen shown in FIG. 8, the left part displays accumulated data folders, which are arranged in chronological order as “e-Filing History” in a list format. Hatching indicates the presence of selected data, and a thick solid line indicates a folder that is currently in use.

The thumbnail icon of page 5 of the folder N−2 displayed on the template forming screen of FIG. 8 is dragged and dropped into a creation screen that is displayed immediately below. Thereby, link information is defined. Further, the dropped thumbnail icon is subjected to editing such as rotation, enlargement and reduction.

If the created style is stored in the auxiliary memory device 8, a style template as shown in FIG. 9 is formed. Since the created style template contains no substantial data, it is displayed by relative information indicative of links and easy-to-understand icons indicative of editing operations.

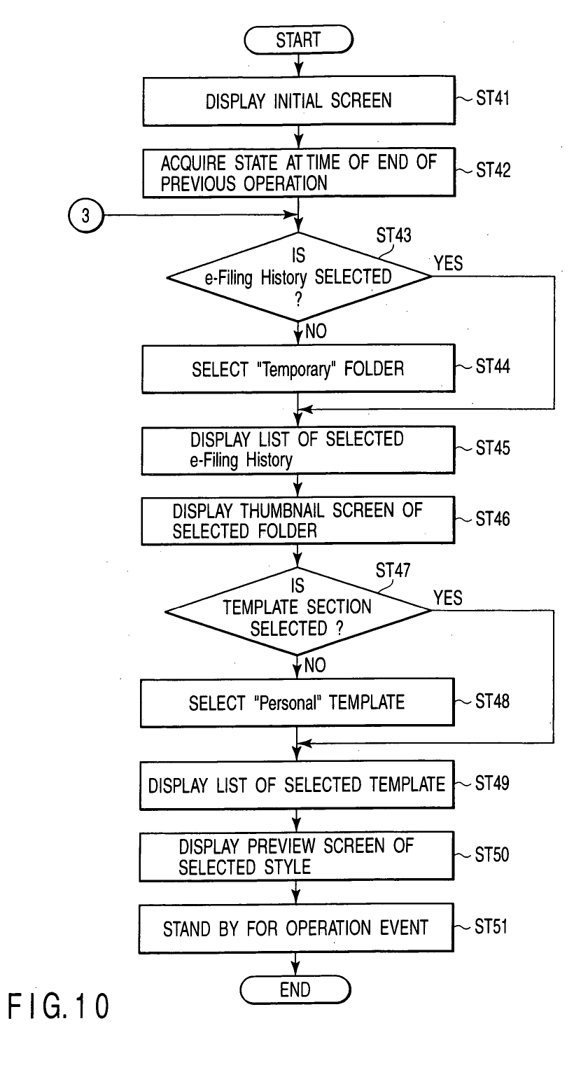

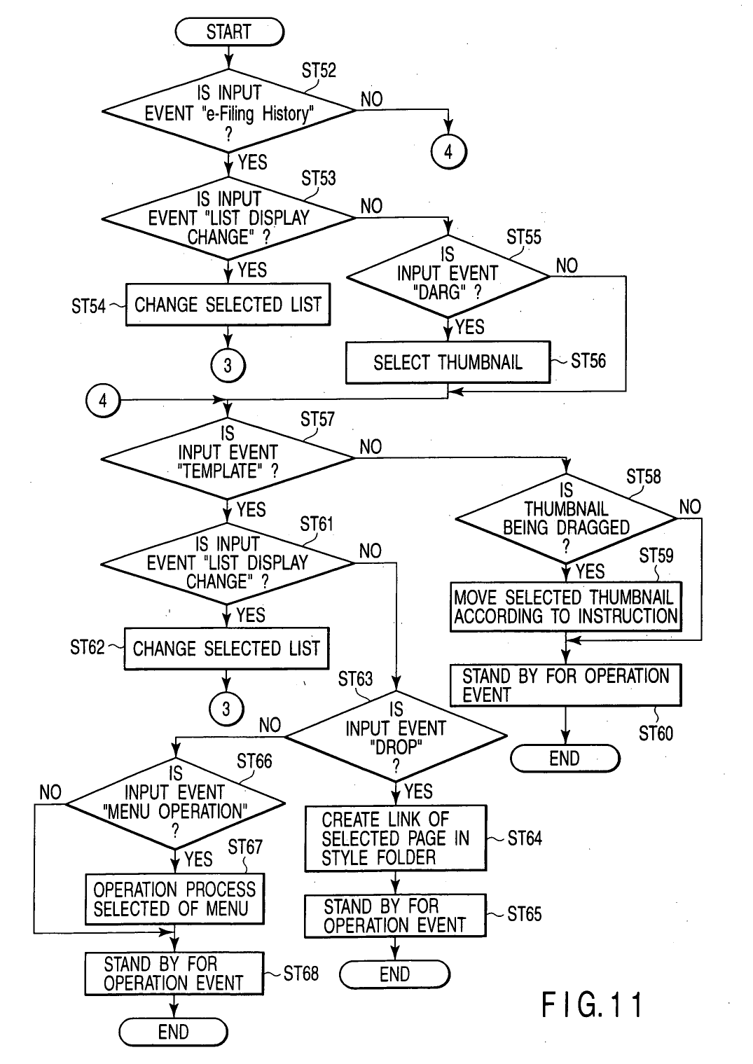

The above-described editing operation is explained referring to flow charts of FIGS. 10 and 11.

In FIG. 10, the CPU 1 causes the key input display device 4 to display an initial screen (ST41), and retrieves the state at the end of the previous operation from the auxiliary memory device 8 (ST42).

The CPU 1 checks whether the e-Filing History section is selected (ST43). If the e-Filing History section is not selected, a “Temporary” folder is selected (ST44).

If the e-Filing History section is selected in step ST43, or after the “Temporary” folder is selected in step ST44, the CPU 1 causes the key input display device 4 to display the list of the selected e-Filing History (ST45) and to display thumbnail icons of the selected folder (ST46).

The CPU 1 checks whether the template section is selected (ST47). If the template section is not selected, “Personal” templates are selected (ST48).

If the template section is selected in step ST47, or after the “Personal” templates are selected in step ST48, the CPU 1 causes the key input display device 4 to display the list of the selected templates (ST49).

The CPU 1 causes the key input display device 4 to display a preview screen of the selected style (ST50), and stands by for an operation event (ST51).

In FIG. 11, if an operation event is input, the CPU 1 checks whether the input event is an e-Filing history or not (ST52).

If the input even is an e-Filing history, the CPU 1 checks whether the input event is a list display change (ST53).

If a list display change occurs in step ST53, the CPU 1 executes the list display change and returns to step ST43 (ST54).

If the input event is not a list display change in step ST53, the CPU 1 determines whether the input event is a drag (ST55). If the input event is a drag in step ST55, a thumbnail is selected (ST56).

If the input event is not an e-Filing history in step ST52, or if the input event is not a drag in step ST55, or if a thumbnail is selected in step ST56, the CPU 1 checks whether the input event is a template or not (ST57).

If the input event is not a template in step ST57, the CPU 1 checks whether a thumbnail is being dragged (ST58). If a thumbnail is being dragged, the selected thumbnail is moved in accordance with an instruction (ST59).

If a thumbnail is not being dragged in step ST58, or after the thumbnail is moved in step ST60, the CPU 1 stands by for an operation event (ST60).

If the input event is a template in step ST57, the CPU 1 checks whether the input event is a list display change (ST61). If a list display change occurs, the CPU 1 executes the list display change and returns to step ST43 (ST62).

If the input event is not a list display change in step ST61, the CPU 1 checks whether the input event is a drop or not (ST63). If the input event is a drop, the CPU 1 creates a link of a selected page in a style folder (ST64) and stands by for an operation event (ST65).

If the input event is not a drop in step ST63, the CPU 1 checks whether the input event is a menu operation or not (ST66). If the input event is a menu operation, the CPU 1 performs an operational process selected on the menu (ST67).

If the input event is not a menu operation in step ST66, or after the operational process is executed in step ST67, the CPU 1 stands by for an operation event (ST68).

An example of printing using the created style template is described below.

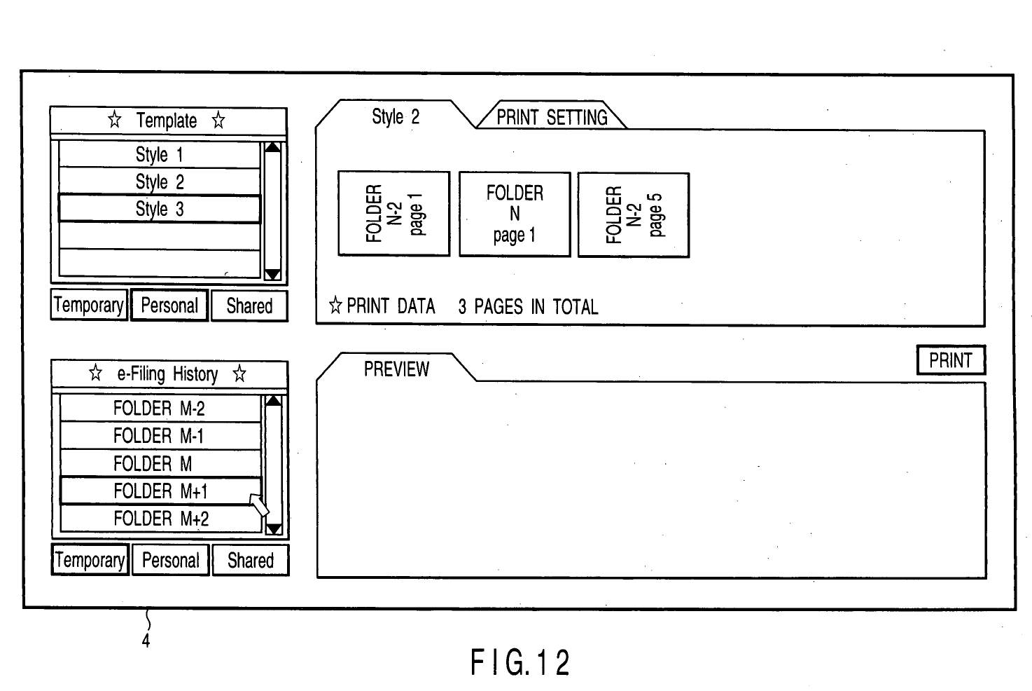

FIG. 12 shows an example of screen display on the key input display device 4, with use of a style template set by relative designation.

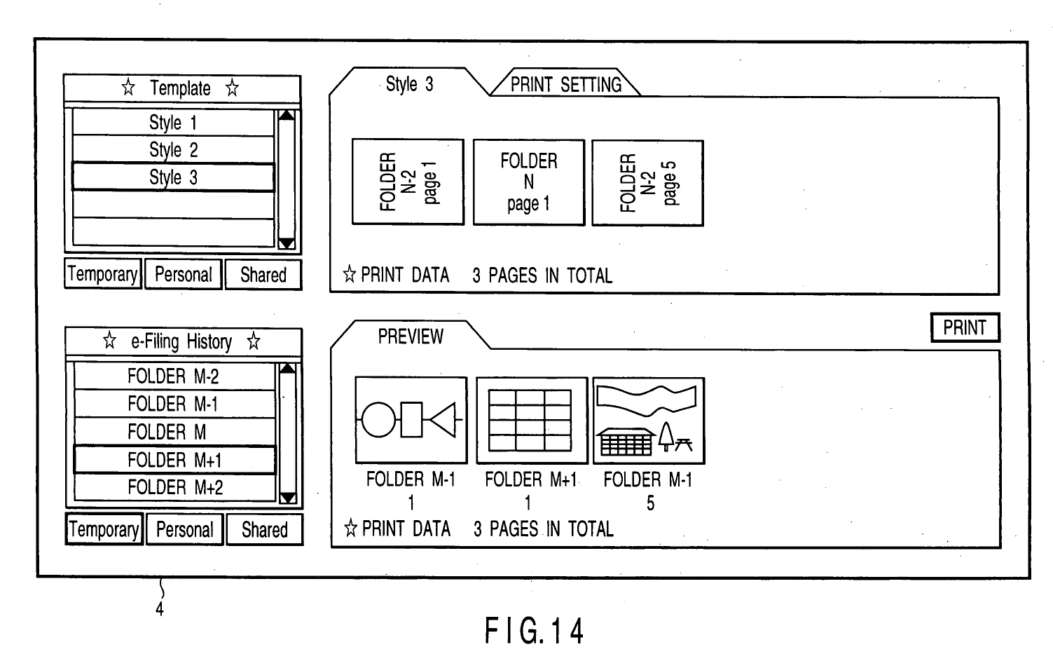

If a folder M+1 is designated as a current folder on the key input display device 4, a preview screen as shown in FIG. 14 is displayed and an obtainable print result can be understood at a glance.

At this time, accumulation data stored in the folder is as shown in FIG. 13.

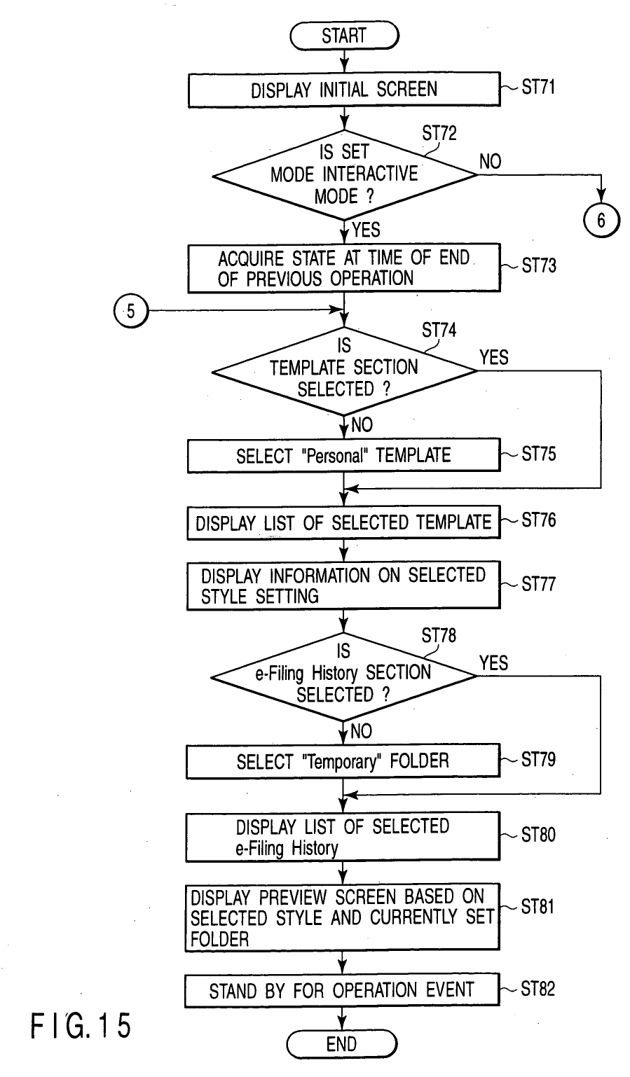

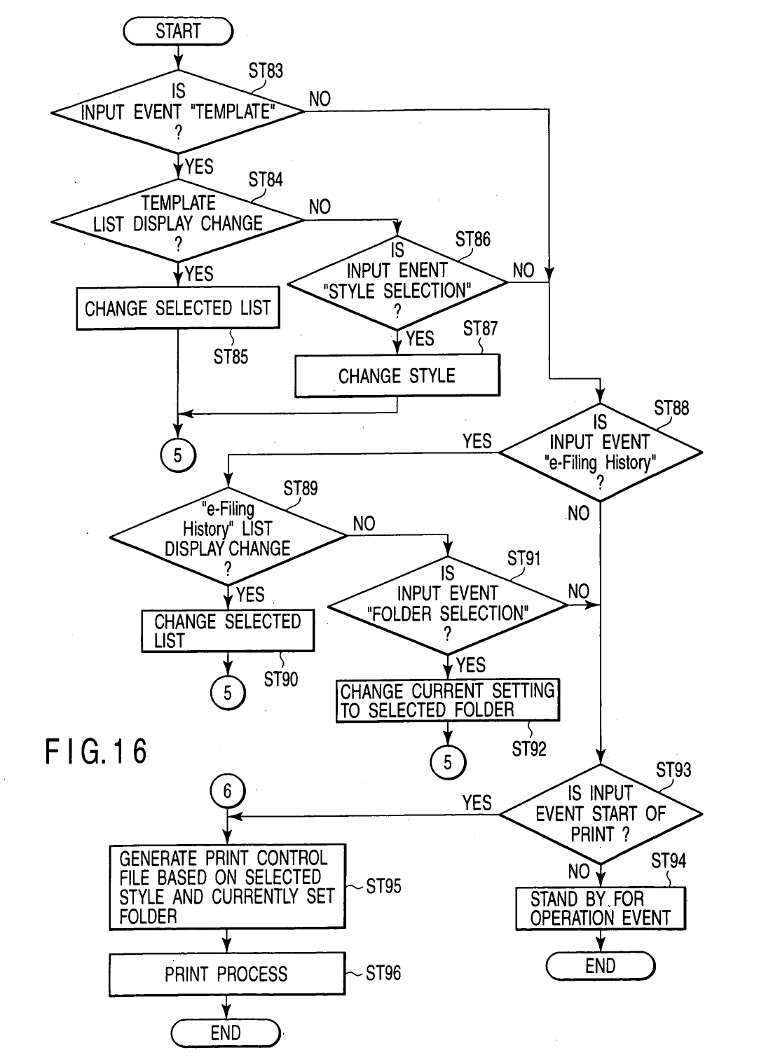

Next, the above-mentioned printing process is described referring to flow charts of FIGS. 15 and 16.

In FIG. 15, the CPU 1 causes the key input display device 4 to display an initial screen (ST41) and checks whether the set mode is an interactive mode or not (ST72).

If the set mode is an interactive mode in step ST72, the CPU 1 retrieves the state at the end of the previous operation from the auxiliary memory device 8 (ST73).

Subsequently, the CPU 1 checks whether the template section is selected (ST74). If the template section is not selected, “Personal” templates are selected (ST75).

If the template section is selected in step ST74, or after the “Personal” templates are selected in step ST75, the CPU 1 causes the key input display device 4 to display the list of the selected templates (ST76), and then causes the key input display device 4 to display setting information of the selected style (ST77).

Then, the CPU 1 checks whether the e-Filing History section is selected (ST78). If the e-Filing History section is not selected, a “Temporary” folder is selected (ST79).

If the e-Filing History section is selected in step ST78, or after the “Temporary” folder is selected in step ST79, the CPU 1 causes the key input display device 4 to display the list of the selected e-Filing history (ST80).

The CPU 1 causes the key input display device 4 to display a preview screen on the basis of the selected style and currently set folder (ST81), and the CPU 1 stands by for an operation event (ST82).

In FIG. 16, when an operation event is input, the CPU 1 checks whether the input event is a template or not (ST83).

If the input event is a template in step ST83, the CPU 1 checks whether the input event is a list display change (ST84). If a list display change occurs, the CPU 1 executes the list display change and returns to step ST74 (ST85).

If the input event is not a template list display change in step ST84, the CPU 1 checks whether the input event is a style selection or not (ST86). If the input event is a style section, the CPU 1 executes a style change and returns to step ST74 (ST87).

If the input event is not a template in step ST83, or if the input event is not a style selection in step ST86, the CPU 1 checks whether the input event is an e-Filing history or not (ST88). If the input even is an e-Filing history, the CPU 1 checks whether the input event is a list display change of the e-Filing history (ST89).

If the input event is a list display change of the e-Filing history in step ST89, the CPU 1 executes a selected list change and returns to step ST74 (ST90).

If the input event is not a list display change of the e-Filing history in step ST89, the CPU 1 checks whether the input event is a folder selection or not (ST91). If the input event is a folder selection in step ST91, the CPU 1 changes current setting to the selected folder and returns to step ST74 (ST92).

If the input event is not an e-Filing history in step ST88, or if the input event is not a folder selection in step ST91, the CPU 1 checks whether the input event is a print start or not (ST93).

If the input event is not a print start in step ST93, the CPU 1 stands by for an operation event (ST94).

If the input event is a print start in step ST93, or if the set mode is not an interactive mode in step ST72, the CPU 1 generates a print control file on the basis of the selected style and the currently set folder (ST95).

The CPU 1 executes a print process based on the generated print control file, and finishes the process (ST96).

Next, as regards the print setting, processing (stapling, punching, etc.) in subsequent steps and the number of copies can be set.

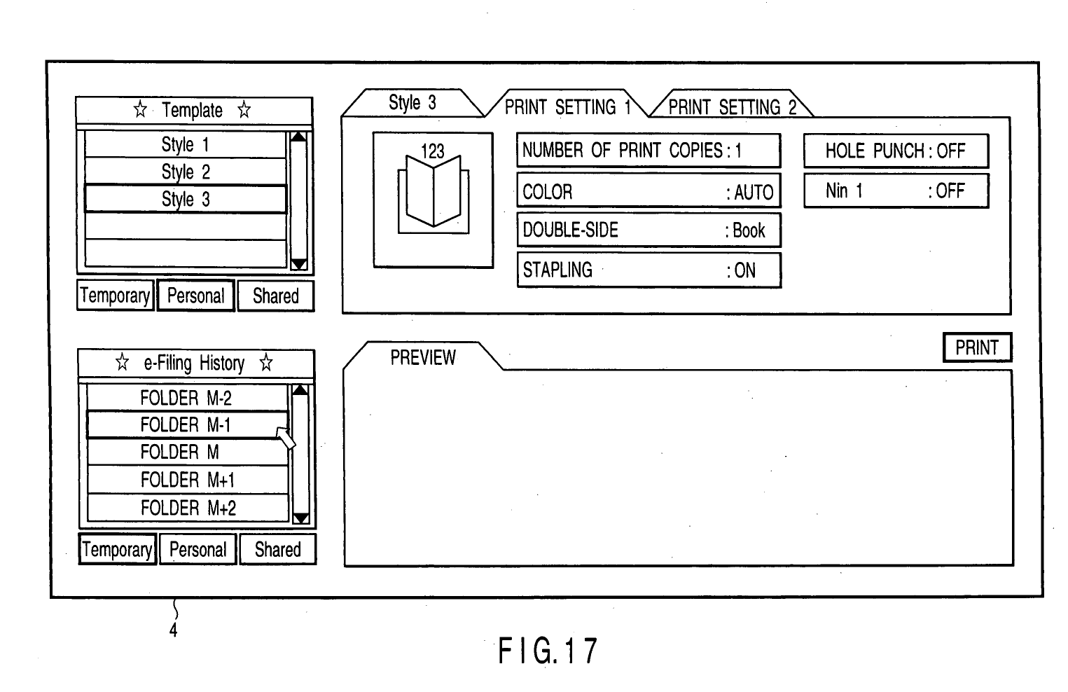

FIG. 17 shows an example of display relating to the print setting on the key input display device 4.

A plurality of print settings can be made, and the respective settings can be printed out. It is also possible to print out all the settings as a batch. If this setting operation is applied, it is possible to execute, by one action, a work that requires two print operations in the prior art, for example, a work comprising a color print operation of two copies and a monochromatic print operation of 10 copies.

Referring to FIG. 17, a description is given of the case where a folder M+1 is designated.

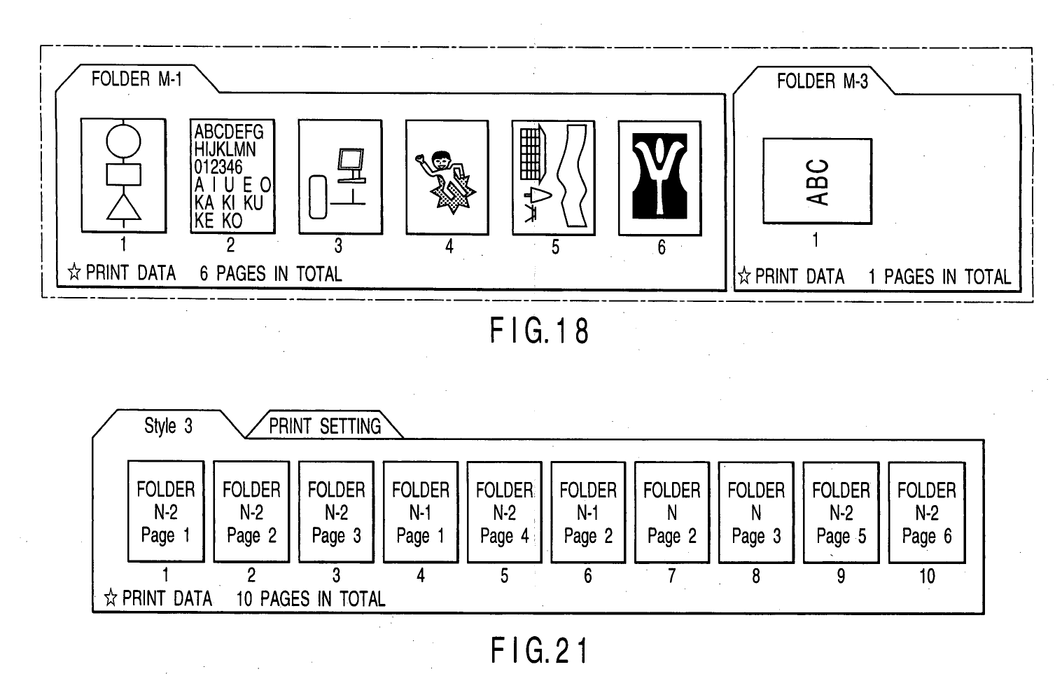

FIG. 18 shows an example of data stored in each folder at this time.

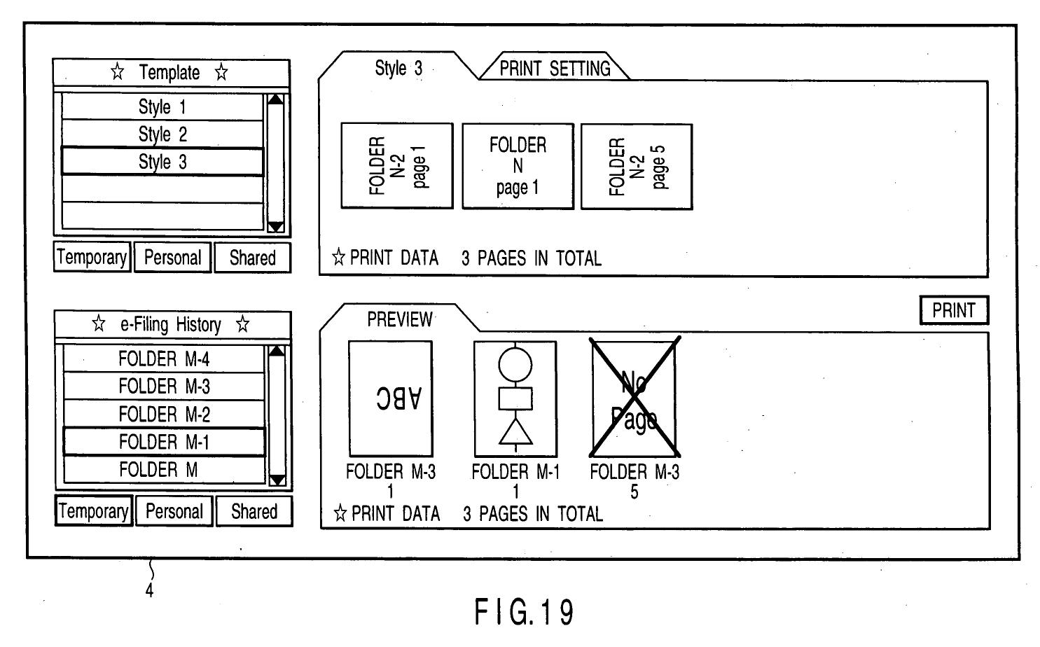

FIG. 19 shows a preview result. In FIG. 19, a page with a mark (X) indicates the absence of data. In this case, a desired print result is not obtained since the style template and accumulated data are unmatched. If the created style template and the order of accumulated data are unmatched, a desired result is not obtained. However, by properly matching the order of data, various print editing can be used repeatedly.

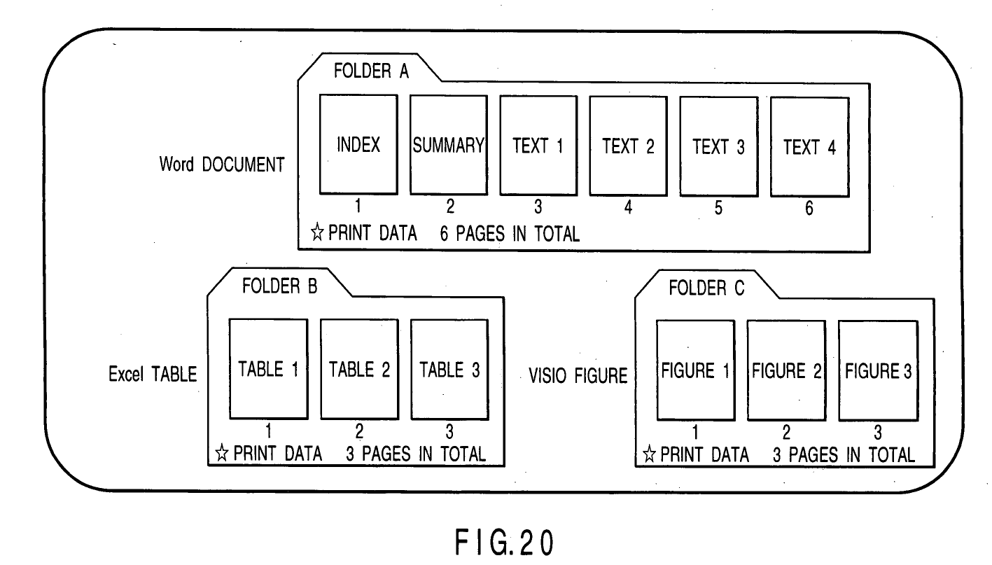

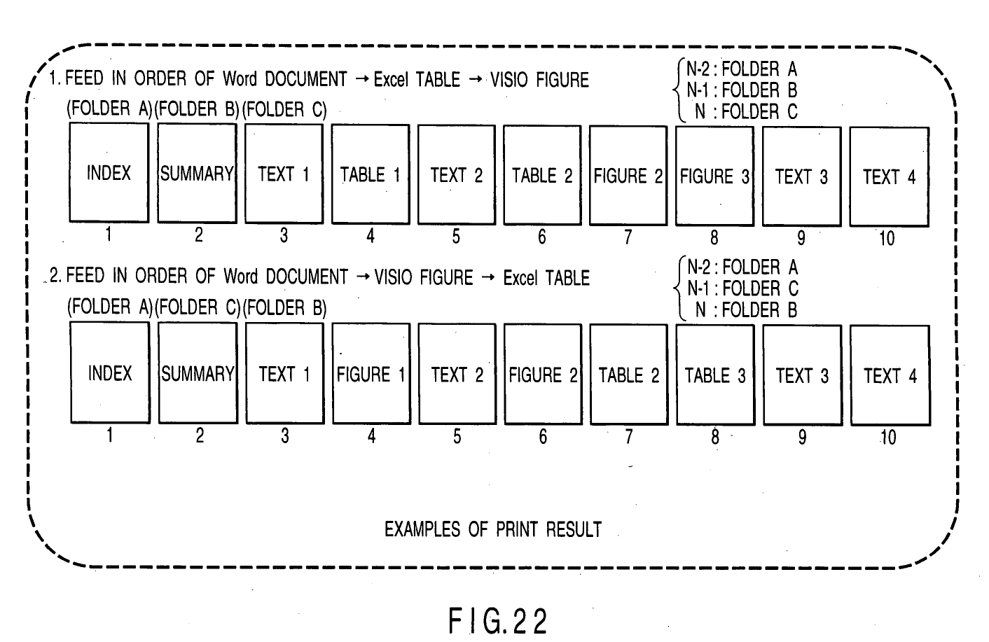

FIG. 20 shows an applied example in which mixed print data from a plurality of applications is printed.

Various style templates, as shown in FIG. 21, are defined in advance. A page is extracted from three print data items only by feeding print data so as to conform to the style template. Thus, the page is printed out as one document.

In FIG. 22, example “1” indicates a case where a Word document shown in FIG. 20 is first fed, following which an Excel™ table is fed secondly and a VISIO™ figure is fed thirdly. Example “1” indicates a case where a Word document is first fed, a VISIO figure is fed secondly and an Excel table is fed thirdly. It is understood that the print results are different.

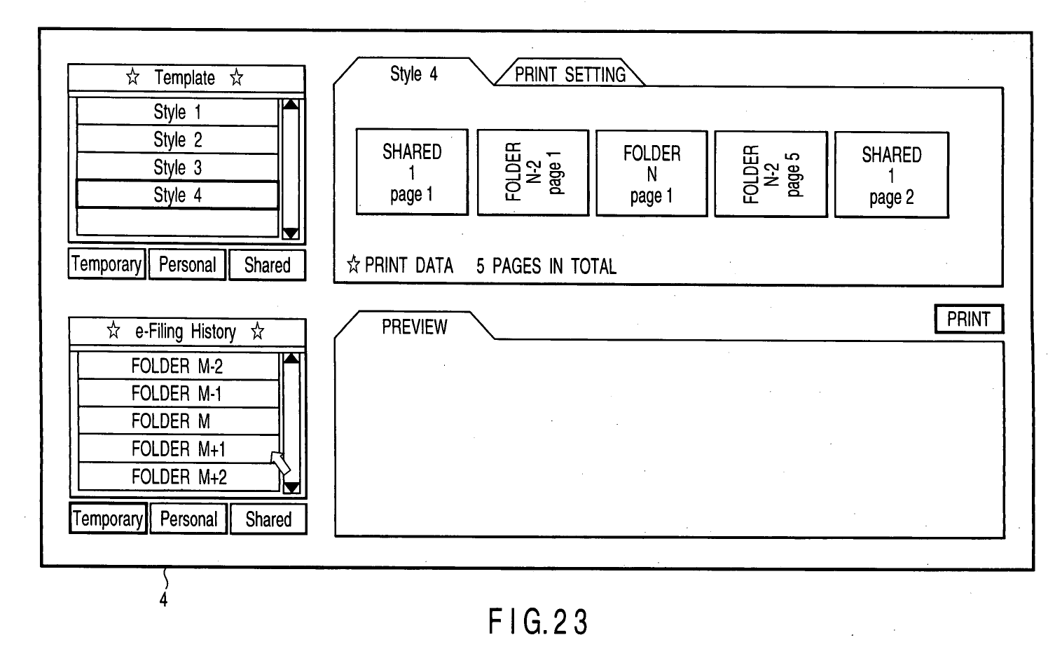

FIG. 23 shows an example of display of print setting on the key input display device 4. This example relates to a case where style 4 is designated.

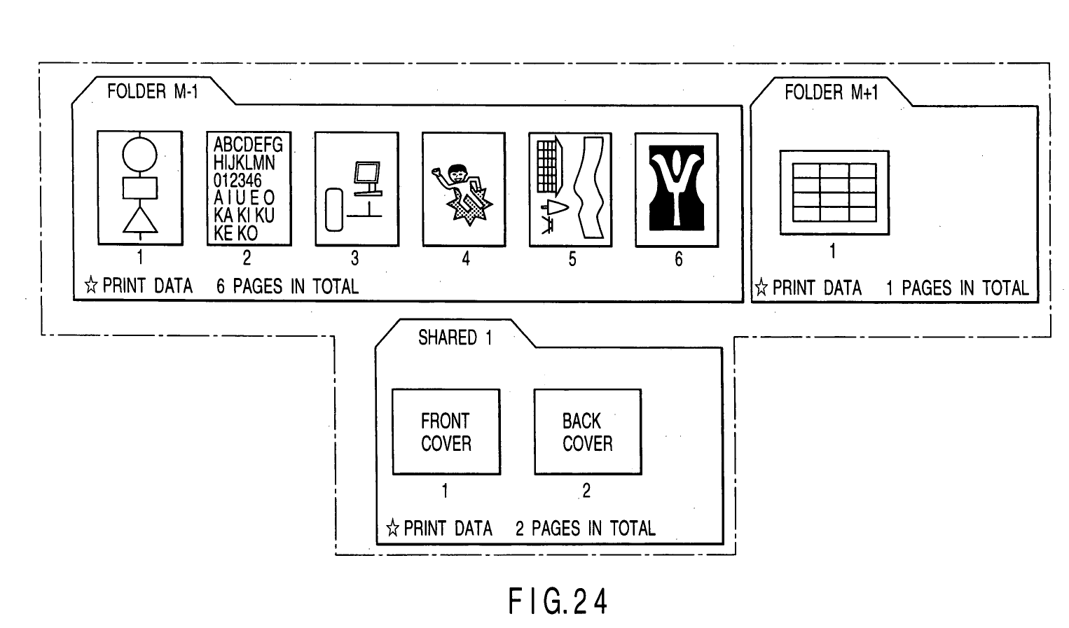

FIG. 24 shows an example of data accumulated in each folder in this case.

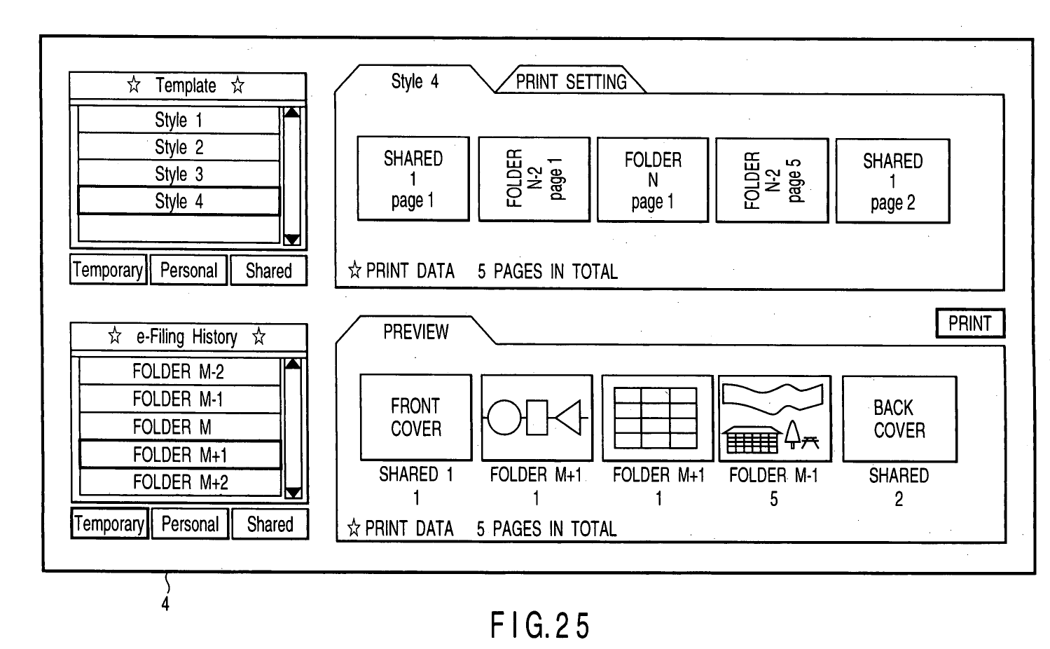

FIG. 25 shows a preview result.

The above-described document replacement function using PDL can be provided not only in the MFP apparatus 10, 11, but also on a communication path reaching the MFP apparatus.

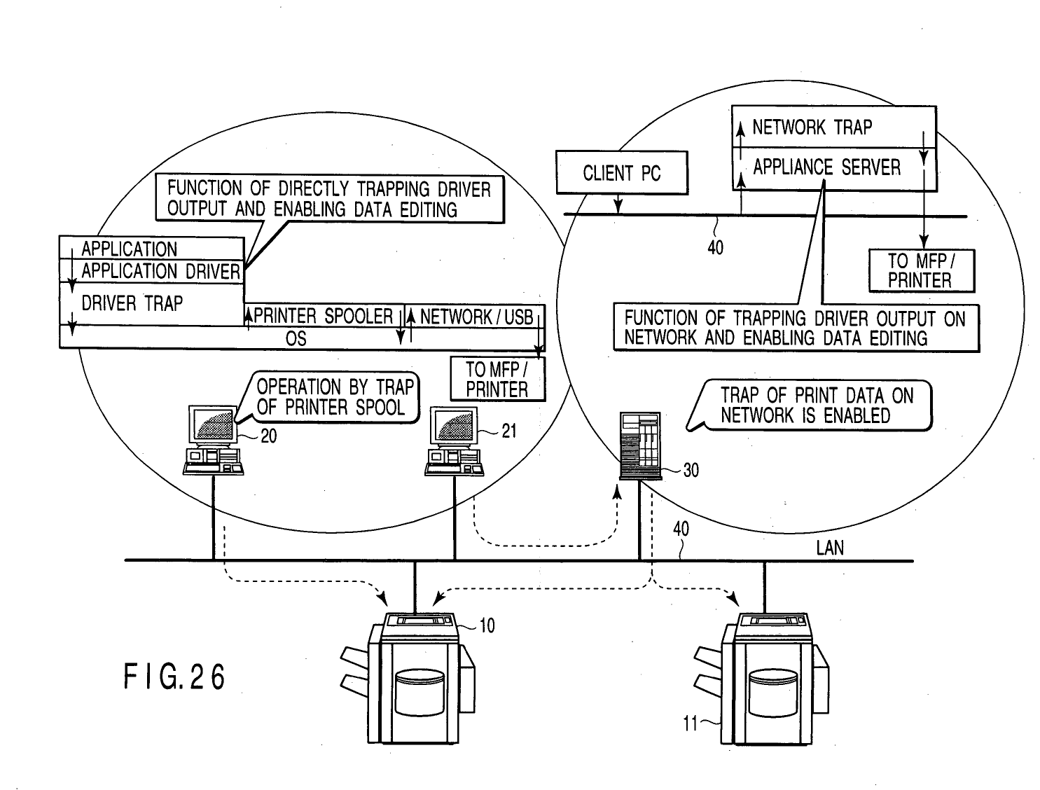

FIG. 26 shows a system configuration wherein a printer driver is equipped with a similar function, thereby to create and edit style templates.

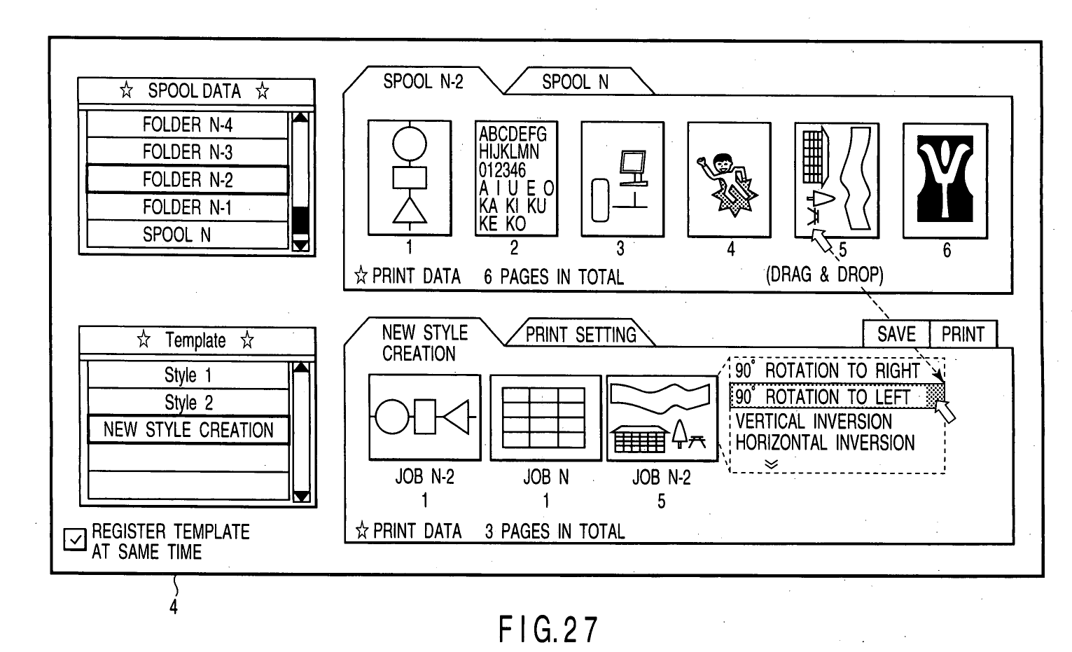

FIG. 27 shows an example of the function provided in the driver. Accumulated data is replaced with SPOOL data. Similarly, the same function may be implemented as one function that is provided by the appliance server 30.

As has been described above, according to the embodiment of the present invention, print data is divided into page units and stored and the print state that is set at the time of printing is also stored at the same time. Thereby, an independent page-unit print can be executed. Hence, restrictions on the editing work are eliminated and the degradation in image quality due to the editing work can be eliminated at the same time.

The print style format that permits relative page designation is adopted. Thus, only by feeding to the MFP apparatus documents from a plurality of applications in succession in a predetermined output order, necessary pages can be gathered from such document data into a single document. Hence, it is possible to make best use of the finishing function that characterizes the MFP apparatus.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A printing system comprising:
input means for inputting print data;
division means for dividing the print data input by the input means into page units;
first addition means for adding print setting state data to the print data of each of the page units divided by the division means;
second addition means for adding page description data to the print data of each of the page units divided by the division means;
generation means for generating a print job control script file in association with the print data divided by the division means; and
print means for performing printing in accordance with the print job control script file generated by the generation means.

2. The printing system according to claim 1, wherein the print data is a Page Description Language.

3. The printing system according to claim 1, wherein the print setting state data is a print setting/definition for return to a print start state of the associated page.

4. The printing system according to claim 1, wherein the page description data is an editing command for enlargement, reduction, rotation and shift.

5. The printing system according to claim 1, wherein the page-unit print data comprises a PDL description section for re-setting the associated page in a print start state; an editing PDL description section that defines variables necessary for performing enlargement, reduction, rotation and shift at a time of re-printing and enables acquisition of a desired editing result by setting of values at a time of print execution; and a PDL description section for actual image rendering, and
the page-unit print data is stored in a folder for the print data, which is provided in storage means.

6. The printing system according to claim 1, wherein the printing system is a multi-function peripheral.

7. The printing system according to claim 1, wherein the printing system is a printer driver.

8. The printing system according to claim 1, wherein the printing system comprises a multi-function peripheral, and a personal computer having communication means for data communication with the multi-function peripheral.

9. The printing system according to claim 1, wherein a multi-function peripheral, a personal computer and an appliance server are connected by communication means.

10. The printing system according to claim 1, further comprising:
storage means for storing page-unit print data in chronological order of storage;
display means for displaying, when the page-unit print data stored in the storage means is selected, the selected page-unit print data as a thumbnail;
setting means for performing data setting by moving the thumbnail that is displayed on the display means; and
second control means for executing a control to generate link information from the set thumbnail and to store the link information in the storage means.

11. The printing system according to claim 10, further comprising:
determining means for determining print data of a to-be-processed page from a current point that is a base point of the link information of the page-unit print data stored in the storage means; and
third control means for executing a control to extract print data of the page determined by the determining means and to preview-display the extracted print data.

12. A method of controlling printing, comprising:
dividing input print data into page units;
adding print setting state data to the print data of each of the divided page units;
adding page description data to the print data of each of the divided page units;
generating a print job control script file in association with the divided print data; and
controlling printing in accordance with the generated print job control script file.

13. The method of controlling printing according to claim 12, wherein the print data is a Page Description Language.

14. A program that causes a printing system, which effects printing using given print data such as a Page Description Language, comprising:
dividing the print data into page units;
adding print setting state data to the print data of each of the divided page units;
adding page description data to the print data of each of the divided page units;
generating a print job control script file in association with the divided print data; and
controlling printing in accordance with the generated print job control script file.
